(19) United States
(12) Patent Application Publication
(10) Pub. No.: US 2011/0192862 A1
(43) Pub. Date: Aug. 11, 2011

(54) WIPE DISPENSER

(76) Inventor: Kellie R. Knudsen, Riverdale, UT (US)

(21) Appl. No.: 13/021,921

(22) Filed: Feb. 7, 2011

Related U.S. Application Data
(60) Provisional application No. 61/301,733, filed on Feb. 5, 2010.

(51) Int. Cl. B65H 3/00; B65D 83/08; F16B 47/00; H01F 7/02; A44B 18/00

(52) U.S. Cl. 221/46; 248/206.3; 248/206.5; 248/205.2; 248/205.3

(57) ABSTRACT

There is a wipe dispenser configured to dispense wipes. The wipe dispenser includes a cartridge including a plurality of damp wipes. The wipe dispenser includes a replacement cap configured to selectably couple to the cartridge, having a bottom aperture configured to dispense a wipe and a reservoir barrier extending upwardly from a top surface of the replacement cap and circumscribing the bottom aperture. The wipe dispenser includes a wall mount coupled to the replacement cap and extending upwardly from a side portion thereof, including coupling device secured to a mounting member. The wipe dispenser includes a cartridge coupling member selectably coupled to the replacement cap and extending upwardly therefrom and configured to support the cartridge.

### CROSS-REFERENCE TO RELATED APPLICATIONS

This invention claims priority, under 35 U.S.C. §120, to the U.S. Provisional Patent Application No. 61/301,733 to Kellie R. Knudsen filed on Feb. 5, 2010, which is incorporated by reference herein.

### BACKGROUND OF THE INVENTION

1. Field of the Invention

The present invention relates to dispensers, specifically a wipe dispenser configured to dispense wipes.

2. Description of the Related Art

A wet wipe, also known as a wet nap, wet towel or a moist towelette, is a small moistened piece of paper or cloth that often comes folded and individually wrapped for convenience. In other cases it is nested in rectangular containers, such as like with facial tissue boxes. In still other cases, it is nested in a roll and housed in cylindrical containers with dispensing holes through the top, such that the wet wipes may be pulled from the inside of the roll out through the top of the container.

Such towelettes are generally for cleansing or disinfecting. Wet wipes have become a standard part of diaper changing kits. They can be bought in packages of 80 or more, and come with dispensing mechanisms. Towelettes are generally moistened with solvents. Cleansing towelettes may include scented water, a surfactant and/or detergent, while disinfecting towelettes are moistened with other solvents, such as but not limited to isopropyl alcohol, bleach, ammonia, and the like. They are often dispensed in restaurants, at service stations, along with airline meals, in doctors' offices, and other similar places. They are often included as part of a standard sealed cutlery package. Wet wipes can also be bought in stores for private usage. In South East Asia, wet wipes are often sold out of refrigerators to gain the refreshing effect.

Wet wipes can serve a number of household purposes. Although marketed primarily for wiping infants' backsides in diaper changing, it is not uncommon for consumers to also use the product to clean floors, toilet seats, and other surfaces around the home. Parents also use wet wipes, or as they are called for baby care, baby wipes, for wiping up baby sick and use to clean babies' hands and face in feeding or general dirtiness. Wet wipes have also found a use among visitors to music festivals, particularly those who camp, as an alternative to the communal showers, for which there are generally extremely long queues. Since the outbreak of Swine Flu sales of individual impregnated wet wipes and gels in sachets and flow packs have dramatically increased in the UK following the Government's advice to keep hands and surfaces clean to prevent the spread of germs. Some improvements have been made in the field. Examples of references related to the present invention are described below in their own words, and the supporting teachings of each reference are incorporated by reference herein:

U.S. Pat. No. 6,786,447, issued to Geib et al., discloses a removable and replaceable lid for use in dispensing sheets such as wet wipes from a container, a dispenser incorporating the lid, and methods of using the lid and dispenser are provided. An intermediate member is hingedly connected to a base member and a top cover member to form a three-part lid. The base member includes an opening and is removably mountable on a container. The intermediate member includes a recessed portion with a slit or webbing, and is engaged with the base member to cover the opening. The top cover member is engaged with the intermediate member to cover the slit. The opening in the base member is sized to permit access to manually withdraw an initial or starter sheet from the roll of sheets disposed within the container so that the sheet can be pushed through the slit in the intermediate member without having to remove the lid from the container.

U.S. Pat. No. 6,158,614, issued to Haines et al., discloses a dispenser of wet wipes from a coreless log includes a semi-cylindrical chimney member in the lid of the container that houses the log or houses a refill cartridge in which the log is disposed. The chimney member is disposed and configured to shelter the main portion of a dispensing opening without sealing the dispensing opening. The chimney member influences the user to extract the wipe in a way that reduces the wasteful incidence of streaming of wipes from the log.

U.S. Pat. No. 6,585,130, issued to Turbett et al., discloses a dispenser for the wipes is described suitable for use in a shower environment, utilizing a shell having opposed top and bottom ends and, in a preferred embodiment, a support device connected to the shell for securing the dispenser to an outside surface. In another embodiment, the dispenser prevents water spray from the shower from contaminating the wipes contained therein. The bottom end has a dispensing slot with a length dimension greater than a width dimension and a finger-access opening to enable the user to urge wipes in the direction of the dispensing slot. The inventive wipe dispenser also is conveniently refilled with disposable wipes.

U.S. Pat. No. 5,697,577, issued to Ogden, discloses a housing is provided having an interior surface defining a chamber. The chamber is sized to receive a pre-moistened toilet paper roll. The chamber is substantially sealed to help prevent the evaporation of the moisture on the toilet paper roll. The housing includes a first end wall, an opposing second end wall, and a tubular side wall extending therebetween. The tubular side wall comprises a C-shaped tube having a first lip and an opposing second lip defining an opening extending therebetween. A door is slidably mounted on the interior surface of the C-shaped tube to selectively cover the opening. By opening the door, the toilet paper positioned within the housing can be dispensed for use. Mounted on the interior surface of the C-shaped tube is a heating pad for warming the moistened toilet paper. A compartment extends off of the housing and includes batteries that are electrically connected to the heating pad for energizing the heating pad. In an alternative embodiment, a light bulb can be positioned within the compartment for heating of the moistened toilet paper.

The inventions heretofore known suffer from a number of disadvantages which include being difficult to use, being limited in use, being limited in application, being limited in adaptability, being inefficient, being expensive, and being ineffective.

What is needed is a wipe dispenser that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available wipe dispensers. Accordingly, the present invention has been developed to provide a wipe dispenser configured to dispense wipes.

According to one embodiment of the invention, there is a wipe dispenser configured to dispense wipes. The wipe dispenser may include a cartridge including a plurality of damp wipes.

The wipe dispenser may include a replacement cap that may be configured to selectably couple to the cartridge, may have a bottom aperture configured to dispense a wipe and/or a reservoir barrier that may be extending upwardly from a top surface of the replacement cap and/or may be circumscribing the bottom aperture. The replacement cap may include a securing thread that may be configured to selectably couple to a receiving thread of the cartridge. The bottom aperture of the replacement cap may include a plurality of protrusions that may be extending inwardly from the perimeter of the bottom aperture which may be configured to help facilitate separation of the wipes.

The wipe dispenser may include a wall mount that may be coupled to the replacement cap and/or may be extending upwardly from a side portion thereof, and may be including a coupling device secured to a mounting member. The wall mount may be coupled to the cartridge coupling member and/or may be configured to secure the wipe dispenser to a wall. The wall mounts may be mount(s) and may be one or more mounts selected from the group consisting of: a plurality of suction cups, a plurality of magnets, a screw and aperture, a nail and aperture, a hook and loop, and adhesive tape.

In addition, the wipe dispenser may include a cartridge coupling member that may be selectably coupled to the replacement cap and/or may be extending upwardly therefrom and/or may be configured to support the cartridge. The cartridge coupling member may include a cylindrical housing. The cartridge coupling member may include a top aperture. The cartridge coupling member may include a hinged door. The cartridge may nest inside the cartridge coupling member and/or the cartridge coupling member may rest inside the replacement cap.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a perspective view of a wipe container and a replacement cap, according to one embodiment of the invention;

FIG. 2 is a partially exploded perspective view of a wipe dispenser, according to one embodiment of the invention;

FIG. 3 is a partially exploded perspective view of a wipe dispenser, according to one embodiment of the invention;

FIG. 4 is a perspective view of a wipe dispenser, according to one embodiment of the invention;

FIG. 5 is a side cross-sectional view of a wipe dispenser, according to one embodiment of the invention; and

FIG. 6 is a side cross-sectional view of a wipe dispenser, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

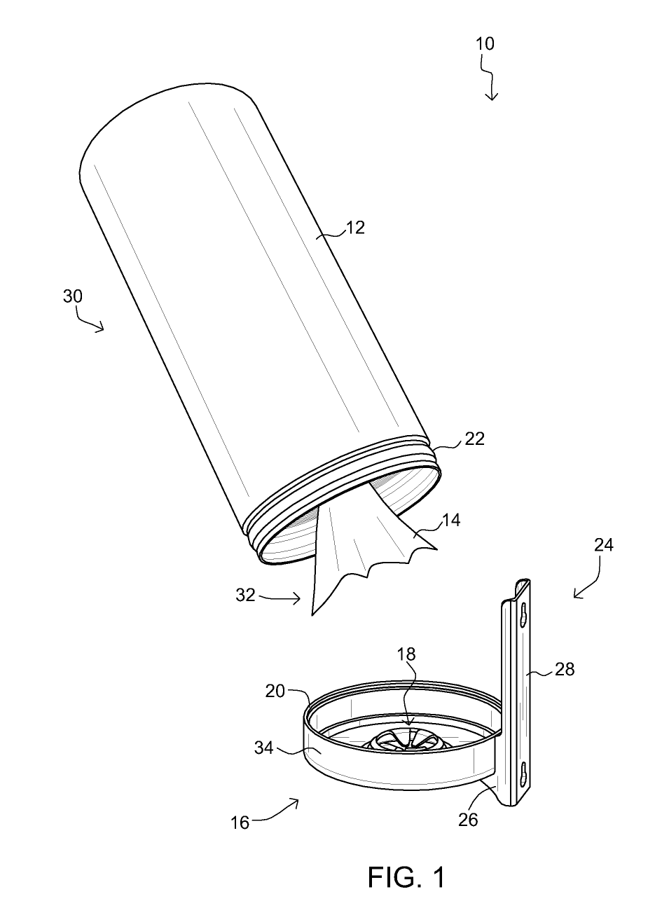

FIG. 1 is a perspective view of a wipe container and a replacement cap, according to one embodiment of the invention. There is a wipe dispenser 10 configured to dispense wipes. The illustrated wipe dispenser 10 includes a cartridge 12 including a plurality of damp wipes 14. Generally the wipes are stored in the cartridge as a roll and wipes are pulled from the center of the roll.

The illustrated wipe dispenser 10 includes a replacement cap 16 configured to selectably couple to the cartridge 12, having a bottom aperture 18 configured to dispense a wipe 14. The illustrated replacement cap 16 includes a securing thread 20 configured to selectably couple to a receiving thread 22 of the cartridge 12. The cartridge 12 is configured to couple to the replacement cap 16 in an invert position 30. The wipe 14 is dispenses through the bottom aperture 18 and the cartridge 12 is configured to dispense the wipe 14 in a downward position 32.

The illustrated wipe dispenser 10 includes a wall mount 24 coupled to the replacement cap 16 and extending upwardly from a side portion 34 thereof. The illustrated wall mount 24 includes a coupling device 26 secured to a mounting member 28. As illustrated in FIG. 1, the wall mount 24 is configured to bolt or screw to a wall or surface to secure the wipe dispenser 10 thereto.

In operation, a user removes a cap or cover of a wipe cartridge and attaches the replacement cap to the cartridge. Then a user installed the wall mount to a wall or other surface such that the wipes may be conveniently dispensed. As non-limiting examples, the wipe dispenser may be placed in a vehicle, a restroom, near a baby changing station, at the entrance to a room or building, and etc.

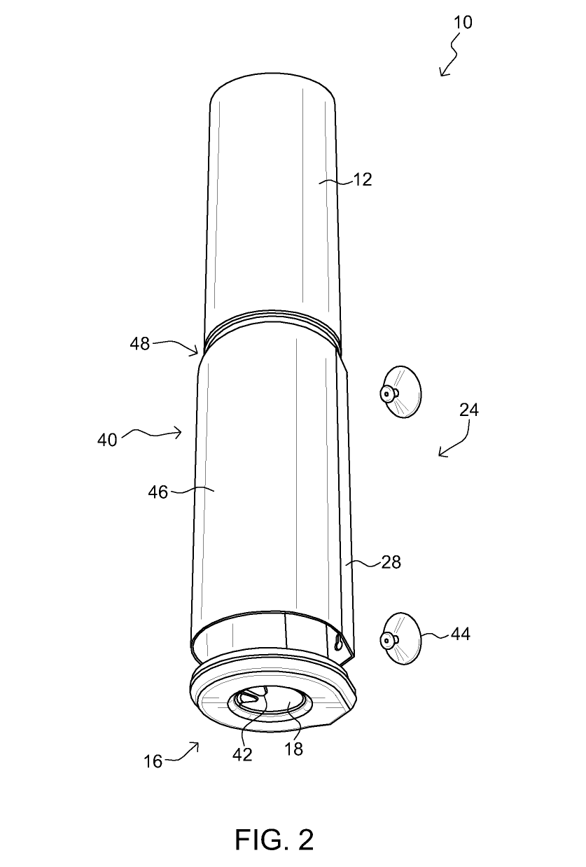

FIG. 2 is a partially exploded perspective view of a wipe dispenser, according to one embodiment of the invention. There is a wipe dispenser 10 including a cartridge 12, a replacement cap 16, and a cartridge coupling member 40.

The illustrated cartridge 12 includes a plurality of damp wipes. The illustrated wipe dispenser 10 includes a replacement cap 16 configured to selectably couple to a cartridge coupling member 40. The illustrated replacement cap 16 includes a bottom aperture 18 configured to dispense a wipe. The illustrated bottom aperture 18 of the replacement cap 16 includes a plurality of protrusions 42 extending inwardly from the perimeter of the bottom aperture 18. The plurality of protrusions 42 help facilitate separation of the wipes by resisting extraction of wipes with force less than the strength of an individual wipe but greater than the attractive force between nested wipes.

The illustrated wipe dispenser 10 includes a wall mount 24 coupled to the cartridge coupling member 40 disposed on a side portion thereof and extending upwardly therefrom. The illustrated wall mount 24 includes a mounting member 28 that is a system of suction cups 44 coupled to an exterior wall of the cartridge. Wall mounts 24 may be selected from the group of mounts consisting of: a plurality of suction cups, a plurality of magnets, a screw and aperture, a nail and aperture, a hook and loop, and adhesive tape. Other wall mount systems and devices in the art, such as but not limited to hooks, adhesive layers, protrusions and the like are contemplated herein. As illustrated in FIG. 2, the wall mount 24 includes a plurality of suction cups 44 configured to secure the wipe dispenser 10 to a wall or surface.

In addition, the illustrated wipe dispenser 10 includes a cartridge coupling member 40 selectably coupled to the replacement cap 16 and extending upwardly therefrom and configured to support the cartridge 12. The cartridge coupling member 40 includes a cylindrical housing 46. The cartridge coupling member 40 includes a top aperture 48 configured to receive the cartridge 12. The cartridge 12 nests inside the cartridge coupling member 40 and the cartridge coupling member 40 rests inside the replacement cap 16.

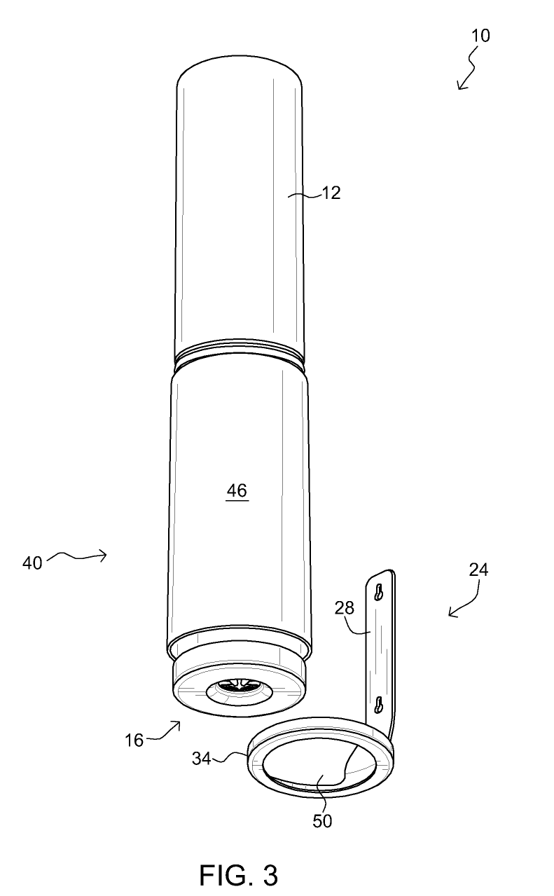

FIG. 3 is a partially exploded perspective view of a wipe dispenser, according to one embodiment of the invention. There is a wipe dispenser 10 including a cartridge 12, a cartridge coupling member 40, a replacement cap 16, and a wall mount 24.

The illustrated wipe dispenser 10 includes a replacement cap 16 configured to selectably couple to the cartridge coupling member 40, having a bottom aperture configured to dispense a wipe. The illustrated replacement cap 16 include a securing thread configured to selectably couple to a receiving thread of the cartridge coupling member 40.

The illustrated wipe dispenser 10 includes a wall mount 24 coupled to the replacement cap 16 and configured to secure the wipe dispenser 10 to a wall. The illustrated wall mount 24 includes a coupling device 34 secured to a mounting member 28. As illustrated in FIG. 3, the coupling device 34 of the wall mount 24 may include a securing thread configured to couple to a receiving thread of the replacement cap 16. The receiving thread of the replacement cap 16 may be disposed on an exterior surface.

The illustrated wipe dispenser 10 includes a cartridge coupling member 40 selectably coupled to the replacement cap 16 and extending upwardly therefrom and configured to support the cartridge 12. The illustrated cartridge coupling member 40 includes a cylindrical housing 46. The illustrated cartridge 12 nests inside the cartridge coupling member 40. The illustrated cartridge coupling member 40 rests inside the replacement cap 16. The illustrated replacement cap 16 rests inside the wall mount 24. The wipe is configured to dispose through the cartridge 12, through a bottom aperture of the cartridge coupling member 40, through the replacement cap 16 and then through an aperture 50 of the wall mount 24.

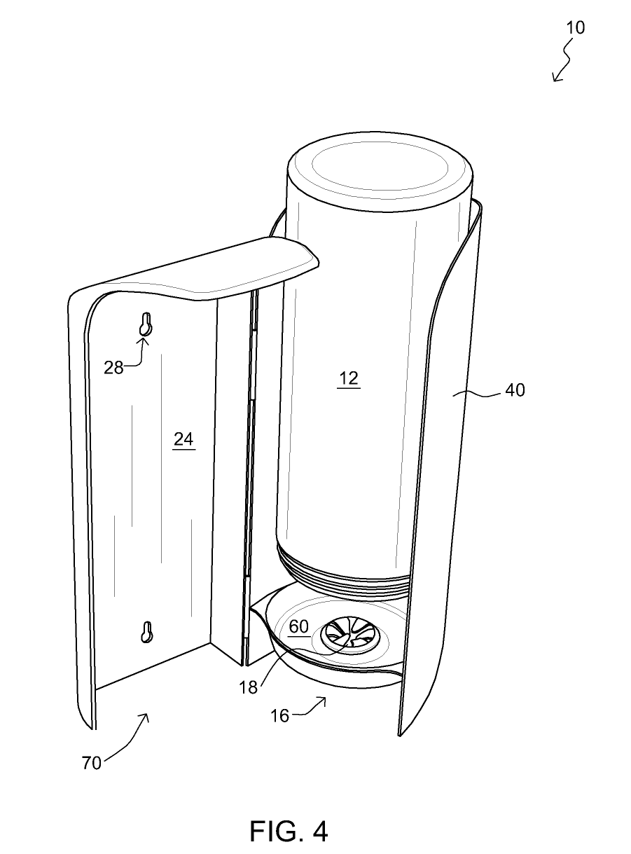

FIG. 4 is a perspective view of a wipe dispenser, according to one embodiment of the invention. There is a wipe dispenser 10 including a cartridge 12, a cartridge coupling member 40, and a replacement cap 16.

The illustrated wipe dispenser 10 includes a replacement cap 16 configured to selectably couple to the cartridge 12, having a bottom aperture 18 configured to dispense a wipe and a reservoir barrier 60 extending upwardly from a top surface of the replacement cap 16 and circumscribing the bottom aperture 18. As illustrated in FIG. 4, the replacement cap 16 is integrated into the cartridge coupling member 40. The cartridge 12 is configured to rest within the replacement cap 16, in an invert position, and supported by the cartridge coupling member 40.

The illustrated wipe dispenser 10 includes a wall mount 24 coupled to the cartridge coupling member 40 extending upwardly from a side portion thereof. The illustrated wall mount 24 includes a mounting member 28 configured to secure the wipe dispenser 10 to a wall or surface.

In addition, the illustrated wipe dispenser 10 includes a cartridge coupling member 40 having a replacement cap 16 and configured to support the cartridge 12. The illustrated cartridge coupling member 40 includes a hinged door 60 configured to secure the cartridge 12 therein. As illustrated in FIG. 4, the wall mount 24 is coupled to the hinged door 60, and the hinged door 70 is configured to secure the wipe dispenser 10 to a wall or surface. The illustrated cartridge 12 nests inside the cartridge coupling member 40 and the cartridge 12 on top of the replacement cap 16.

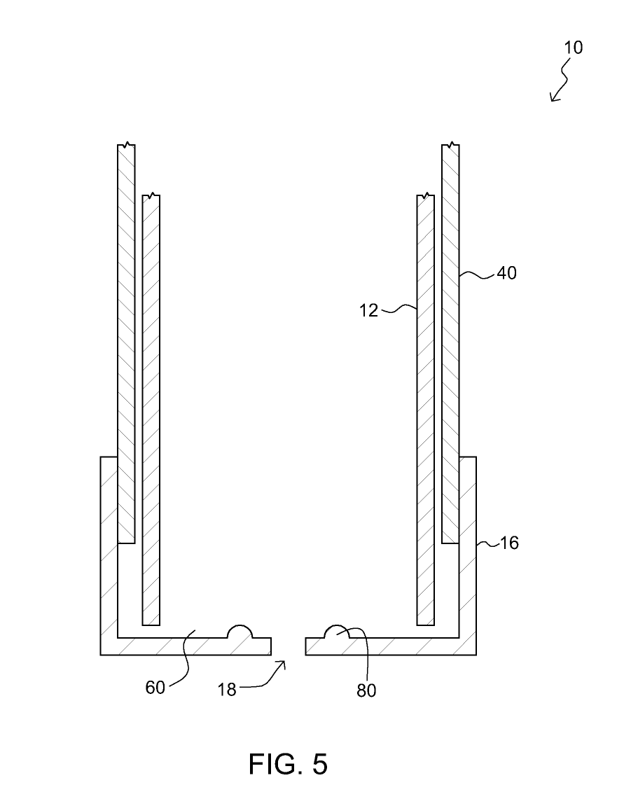

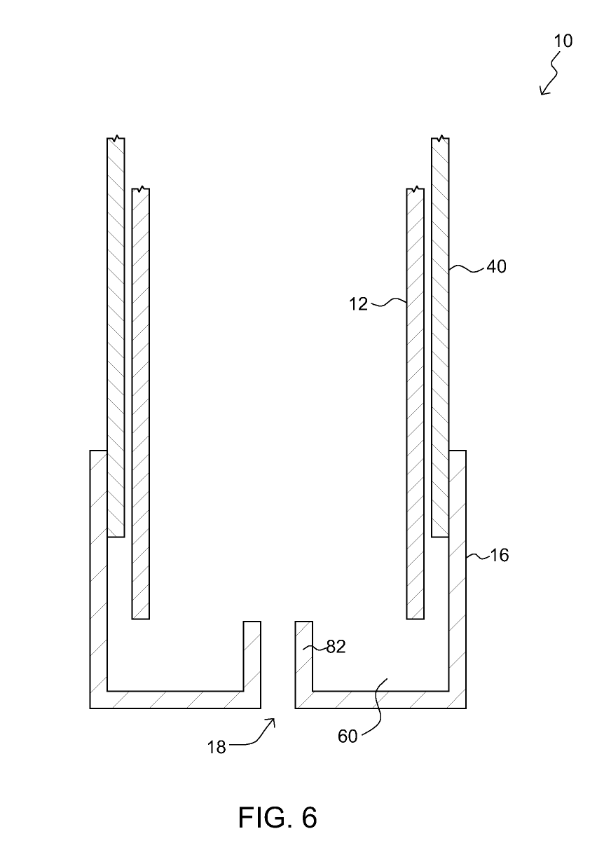

FIGS. 5 and 6 illustrate side cross-sectional views of a wipe dispenser, according to one embodiment of the invention. There is shown a wipe dispenser 10 includes a cartridge 12, a cartridge coupling member 40, and a replacement cap 16.

The illustrated wipe dispenser 10 include a replacement cap 16 configured to selectably couple to the cartridge 12, having a bottom aperture 18 configured to dispense a wipe and a reservoir barrier 60 extending upwardly from a top surface of the replacement cap 16 and circumscribing the bottom aperture 18. As illustrated in FIG. 5, the reservoir barrier 60 includes a protrusion 80 configured to hold liquid therein. As illustrated in FIG. 6, the reservoir barrier 60 includes a reservoir wall 82 configured to support and hold liquid therein.

The wipe dispenser 10 includes a cartridge coupling member 40 selectably coupled to the replacement cap 16 and extending upwardly therefrom and configured to support the cartridge 12. The cartridge 12 nests inside the cartridge coupling member 40 and the cartridge coupling member 40 rests inside the replacement cap 16.

### Examples

The following prophetic examples, each describe one embodiment of the invention. The wipe dispenser is disposed in a cabinet closet next to the sink, coupled to the wall of the cabinet closet by the wall mount. The user is preparing a meal for his/her family and needs to wash his/her hands before touching other cooking utensils or the faucet. The user quickly pulls a wet wipe from the bottom aperture and sanitizes his/her hands, thereby not contaminating other cooking utensils of the faucet.

In another embodiment of the invention, there is a wipe dispenser disposed in a bathroom next to the sink, coupled to the wall with the wall mount. The user has just used the bathroom and before using the faucet the user pulls one wet wipe from the bottom aperture and sanitizes his/her hands before using the faucet. In addition, the user may pull a wet wipe from the bottom aperture to clean the toilet seat before use or door handle before leaving.

In yet another embodiment of the invention, there is a wipe dispenser disposed at a gas station, next to a gas pump, coupled to a fixture by the wall mount. The user accidently spills gasoline on his/her hands, typically the normal paper towel available next to the gasoline pump does not sanitize the gasoline and also doesn't remove the odor. The user pulls a wet wipe from the bottom aperture and sanitizes his/her hand quickly after the spill. The user doesn't need to rush inside to the bathroom of the gas station to wash his/her hands.

In another embodiment of the invention, there is a wipe dispenser that may be disposed in airports, airplanes, hospitals, shopping malls, garages, commercial buildings, manufacturing plants, restaurants, grocery stores, in cars, etc and is configured to provide wet wipes through a bottom aperture.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the Figures illustrate a wall mount, one skilled in the art would appreciate that the wall mount may be, but not limited to: straps, bungee attachments, magnets, hook and loop coupling devices, Velcro straps, adhesive, clamps, bolts, screws, nails, a slideably coupleable mount, and still perform its intended function.

While the illustrations show coupling a replacement cap to a cartridge through nesting and/or threaded coupling, such connections may be made in other ways, such as but not limited to friction fitting, tongue and groove, notched seating, hook and loop, keyed seating, adhesive, combinations thereof, and the like.

Additionally, although the figures illustrate a star shaped bottom aperture, one skilled in the art would appreciate that the aperture may vary in size, shape, design, configuration, color, length, height, width, and still perform its intended function.

It is also envisioned that cartridge coupling member may vary in size, shape, design, configuration, color, height, length, width, and still perform its intended function.

It is expected that there could be numerous variations of the design of this invention. An example is that the replacement cap or cartridge may include a refilling port configured to replace the wet wipes or the fluid contained with the cartridge or replacement cap, and still perform its intended function.

Finally, it is envisioned that the components of the device may be constructed of a variety of materials, such as but not limited to plastic, plastic composite, metal, metal alloys, rubber, rubber composite, glass, carbon fiber, textiles, etc. and still perform its intended function.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A wipe dispenser configured to dispense wipes, comprising:
a) a cartridge including a plurality of damp wipes;
b) a replacement cap configured to selectably couple to the cartridge, having a bottom aperture configured to dispense a wipe and a reservoir barrier extending upwardly from a top surface of the replacement cap and circumscribing the bottom aperture;
c) a wall mount coupled to the replacement cap and extending upwardly from a side portion thereof, including coupling device secured to a mounting member; and
d) a cartridge coupling member selectably coupled to the replacement cap and extending upwardly therefrom and configured to support the cartridge.

2. The dispenser of claim 1, wherein the wall mount is coupled to the cartridge coupling member and configured to secure the wipe dispenser to a wall.

3. The dispenser of claim 1, wherein cartridge coupling member further comprises a cylindrical housing.

4. The dispenser of claim 1, wherein the cartridge coupling member further comprises a top aperture.

5. The dispenser of claim 1, wherein the cartridge coupling member further comprises a hinged door.

6. The dispenser of claim 1, wherein the cartridge nests inside the cartridge coupling member and wherein the cartridge coupling member rests inside the replacement cap.

7. The dispenser of claim 1, wherein the replacement cap further comprises a securing thread configured to selectably couple to a receiving thread of the cartridge.

8. The dispenser of claim 1, wherein the bottom aperture of the replacement cap further comprises a plurality of protrusions extending inwardly from the perimeter of the bottom aperture configured to help facilitate separation of the wipes.

9. The dispenser of claim 1, wherein the wall mounts are selected from the group of mounting devices consisting of:
a plurality of suction cups, a plurality of magnets, a screw and aperture, a nail and aperture, a hook and loop, and adhesive tape.

10. A wipe dispenser configured to dispense wipes, comprising:
a) a cartridge including a plurality of damp wipes;
b) a replacement cap configured to selectably couple to the cartridge, having a bottom aperture configured to dispense a wipe;
c) a wall mount coupled to the replacement cap and extending upwardly from a side portion thereof, including coupling device secured to a mounting member; and
d) a cartridge coupling member selectably coupled to the replacement cap and extending upwardly therefrom and configured to support the cartridge.

11. The dispenser of claim 10, wherein the replacement cap further comprises a reservoir barrier extending upwardly from a top surface of the replacement cap and circumscribing the bottom aperture.

12. The dispenser of claim 11, wherein the wall mount is coupled to the cartridge coupling member and configured to secure the wipe dispenser to a wall.

13. The dispenser of claim 12, wherein cartridge coupling member further comprises a cylindrical housing.

14. The dispenser of claim 13, wherein the cartridge coupling member further comprises a top aperture.

15. The dispenser of claim 14, wherein the cartridge coupling member further comprises a hinged door.

16. The dispenser of claim 15, wherein the cartridge nests inside the cartridge coupling member and wherein the cartridge coupling member rests inside the replacement cap.

17. The dispenser of claim 16, wherein the replacement cap further comprises a securing thread configured to selectably couple to a receiving thread of the cartridge.

18. The dispenser of claim 17, wherein the bottom aperture of the replacement cap further comprises a plurality of protrusions extending inwardly from the perimeter of the bottom aperture configured to help facilitate separation of the wipes.

19. The dispenser of claim 18, wherein the wall mounts are selected from the group of mounting devices consisting of:
a plurality of suction cups, a plurality of magnets, a screw and aperture, a nail and aperture, a hook and loop, and adhesive tape.

20. A wipe dispenser configured to dispense wipes, comprising:
a) a cartridge including a plurality of damp wipes;
b) a replacement cap configured to selectably couple to the cartridge, having a bottom aperture configured to dispense a wipe and a reservoir barrier extending upwardly from a top surface of the replacement cap and circumscribing the bottom aperture; wherein the replacement cap further comprises a securing thread configured to selectably couple to a receiving thread of the cartridge; wherein the bottom aperture of the replacement cap further comprises a plurality of protrusions extending inwardly from the perimeter of the bottom aperture configured to help facilitate separation of the wipes;
c) a wall mount coupled to the replacement cap and extending upwardly from a side portion thereof, including coupling device secured to a mounting member; wherein the wall mounts are selected from the group of mounting devices consisting of:
a plurality of suction cups, a plurality of magnets, a screw and aperture, a nail and aperture, a hook and loop, and adhesive tape; and
d) a cartridge coupling member selectably coupled to the replacement cap and extending upwardly therefrom and configured to support the cartridge; wherein the wall mount is coupled to the cartridge coupling member and configured to secure the wipe dispenser to a wall; wherein cartridge coupling member further comprises a cylindrical housing; wherein the cartridge coupling member further comprises a top aperture; wherein the cartridge coupling member further comprises a hinged door; wherein the cartridge nests inside the cartridge coupling member and wherein the cartridge coupling member rests inside the replacement cap.
